(19) United States
(12) Patent Application Publication
(10) Pub. No.: US 2007/0267863 A1
(43) Pub. Date: Nov. 22, 2007

(54) Business card with multi-year calendar

(76) Inventor: Yi-Cheng Chang, Willowbrook, IL (US)

Correspondence Address: FRANK C. NICHOLAS;CARDINAL LAW GROUP, 1603 Orrington Avenue, Suite 2000, Evanston, IL, 60201, US

(21) Appl. No.: 11/436,868

(22) Filed: May 18, 2006

(51) Int. Cl. B42D 15/00

(52) U.S. Cl. 283/61

(57) ABSTRACT

A business card includes a front face and a back face, the front face including contact information and days of interest and the back face including a one day per week multi-year calendar defining a plurality of years. In an embodiment, days of interest are printed on the card. A method of printing a business card includes printing contact information on a front face of a card, and printing a one day per week multi-year calendar defining a plurality of years on a back face of the card. A method of promoting a business includes determining a selected day based on the business, printing a card, the card comprising contact information and a one day per week multi-year calendar defining a plurality of years, the day based on the selected day, and distributing the card to a plurality of customers.

### FIELD OF THE INVENTION

This invention relates generally to business cards. More specifically, the invention relates to a business card including a multi-year calendar.

### BACKGROUND OF THE INVENTION

Many professionals, such as sales persons, managers, and business owners, utilize business cards as a portion of promoting their business or affiliations. Business cards generally include contact information such as name, address, phone number, title and business or affiliation. Some cards include logos as well as other graphical devices intended to convey a positive image of the professional or business. Indeed, many other entities also use business cards, even though the entity may or may not be “for profit.” For example, churches and/or synagogues may use business cards for clerics. Thus, the term “business” as used herein encompasses businesses that are for profit, not for profit, associated with secular or nonsecular entities and otherwise has a broad definition.

Some professionals and business people desire that the card be viewed frequently by recipients and include useful information on the card in an attempt to ensure frequent usage. Often, this useful information includes a one year calendar. However, one year calendar cards lose much of their useful advantages after the calendar has passed. For example, a card with a 2005 calendar is useful only for a sense of history after 2005. The size of business cards limits the length of ordinary calendars, and generally only one year is defined by a business card calendar—after passage of the year, the calendar loses utility. Additionally, prior cards do not incorporate important date information, such as holidays or time changes. Smaller font sizes are difficult to read and bigger cards do not fit in common card-sized holders, such as wallets, Rolodex® carriers or the like.

Therefore, it would be desirable to provide a business card and method that overcomes the aforementioned and other disadvantages.

### SUMMARY OF THE INVENTION

One aspect of the invention provides a business card that includes a front face and a back face, the front face including contact information and the back face including a one day per week multi-year calendar defining a plurality of years.

Another aspect of the invention provides a method of printing a business card. The method includes printing contact information on a front face of a card, and printing a one day per week multi-year calendar defining a plurality of years on a back face of the card.

Yet another aspect of the invention provides a method of promoting a business. This method includes determining a selected day based on the business, printing a card, the card comprising contact information and a one day per week multi-year calendar defining a plurality of years, the day based on the selected day, and distributing the card to a plurality of customers.

The aforementioned, and other features and advantages of the invention will become further apparent from the following detailed description of the presently preferred embodiments, read in conjunction with the accompanying drawings. The detailed description and drawings, which are not to scale, are merely illustrative of the invention rather than limiting, the scope of the invention being defined by the appended claims and equivalents thereof.

### BRIEF DESCRIPTION OF THE DRAWINGS

FIG. 1 is a view of one embodiment of a business card, in accordance with one aspect of the present invention;

FIG. 2 is a front view of one embodiment of a business card, in accordance with one aspect of the present invention;

FIG. 3 illustrates one embodiment of a method for printing a business card in accordance with one aspect of the invention; and

FIG. 4 illustrates an embodiment of a method for promoting a business in accordance with one aspect of the invention.

### DETAILED DESCRIPTION OF THE DRAWINGS

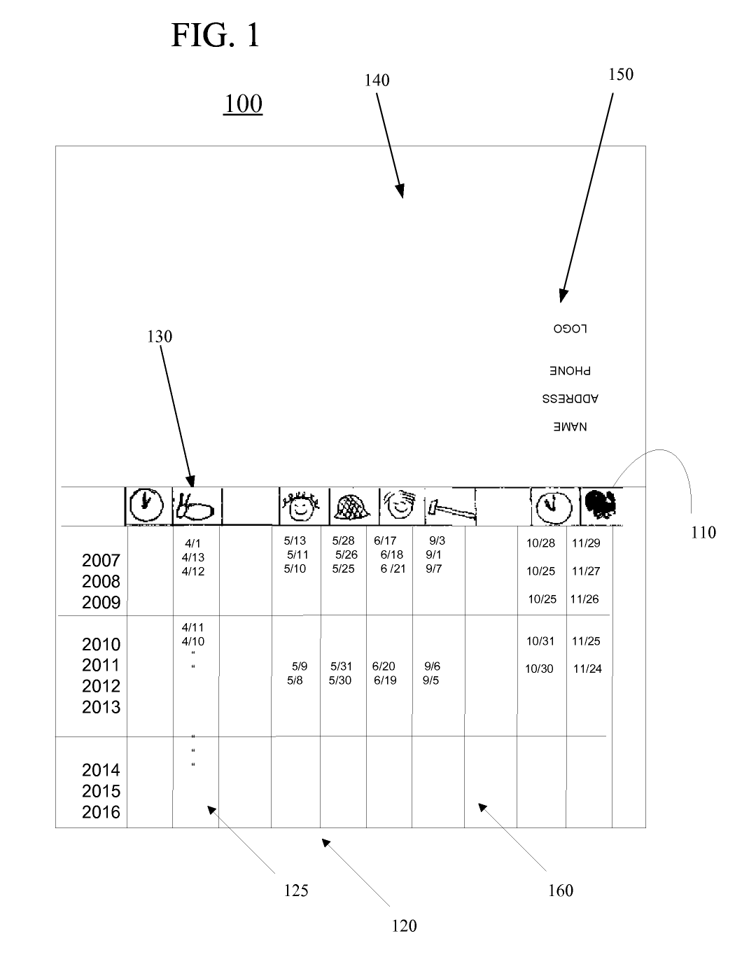

FIG. 1 illustrates a front face 100 of a business card in accordance with one aspect of the invention. The front face includes contact information 150 such as name, address, phone number, email or internet information. Additionally, the contact information 150 is contained within a contact portion 140 of the front face. Front face 100 is bisected by scoring line 110, as shown in FIG. 1, but other embodiments of the invention do not feature a scoring line, while other embodiments feature a plurality of scoring lines.

In addition, front face 100 includes a day of interest portion 120 including day of interest information 125, and as shown in FIG. 1, at least one day of interest icon 130. The icon 130 is an icon associated with a particular day of interest. For example, a rabbit icon is associated with Easter, a clock icon is associated with changes to/from daylight savings time, a turkey is associated with Thanksgiving, a woman's face is associated with Mother's Day, etc. Other or different icons can be associated with various holidays. In one embodiment, at least one blank column 160 is inserted in the day of interest portion, such that a user can insert personally important days, such as for example, birthdays, anniversaries, or the like. Alternatively, the day of interest portion includes business messages in one embodiment. A business message can be a listing of the products or services offered by the business, an indication of specialization or experience, a recitation of customer comments or ratings from an analysis agency, a slogan, a mission statement, a territory or affiliated entity list, a story, an anecdote, a joke, or the like. In another embodiment, the business message is printed only in the blank column 160, while other holiday information remains printed.

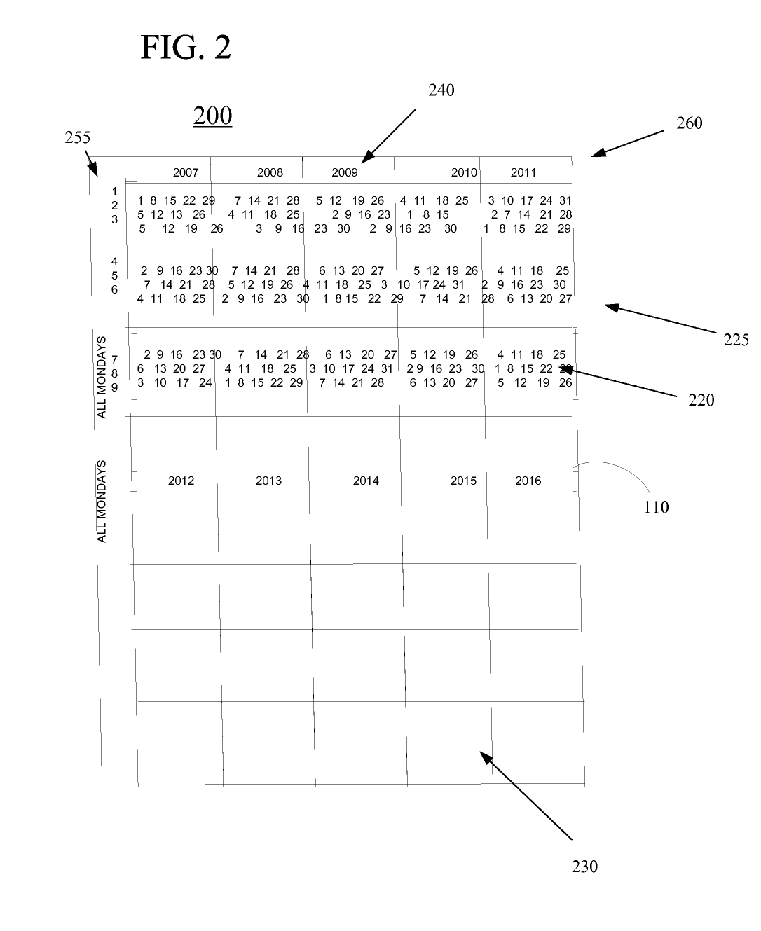

FIG. 2 illustrates a back face 200 of a business card in accordance with one aspect of the invention. Back face 200 includes a one day 220 per week calendar 230 defining a plurality of years 240. The calendar 230 is in a calendar portion. As shown at 200, 10 years are defined by the calendar (2007-2017). In other embodiments, 12 years can be illustrated. In another embodiment, less than 10 years are illustrated. Only one day 220 per week is shown by the calendar. FIG. 2 illustrates the one day as Monday, although any day of the week, such as Saturday or Sunday could be used. For example, a for profit business may choose to use Mondays, while a church might choose Sunday, and a temple might choose Friday or Saturday. FIG. 2 further illustrates back face 200 bisected by score 110.

The calendar is presented, for example, in a tabular format, with each year displayed in a column and each selected day for a given month displayed in a row with the given month. In one embodiment, additional visual reference lines are printed, for example, every three rows, to assist in reading. In one embodiment, a numeric representation of the month (i.e. 1=January, 2=February) is displayed in a first column 255 on a first side, while an alphabetic representation of the month (i.e. J=January, F=February or JAN=January, FEB=February) is displayed in a second column 260 opposing the first column 255. A notation 225 of the selected day (i.e “ALL MONDAYS”) is displayed.

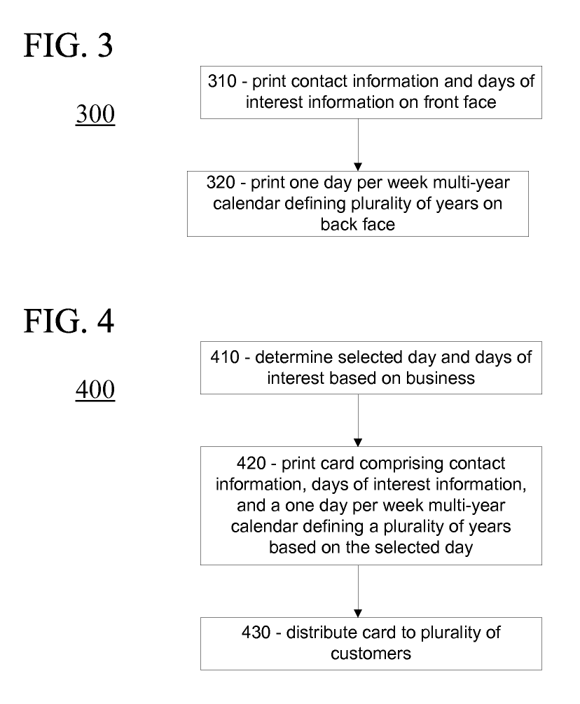

FIG. 3 illustrates one method 300 for printing a business card, in accordance with one aspect of the invention. Method 300 begins at 310 by printing contact information on a front face of a card. The contact information is, in one embodiment, contact information 150 as described above. In one embodiment, day of interest information is also printed on the front face of the card. Method 300 continues at step 320 by printing a one day per week multi-year calendar defining a plurality of years on a back face of the card.

In one embodiment, method 300 includes printing the contact information on a first portion of the front face and the one day per week multi-year calendar is printed on a second portion of the back face. In one embodiment, the method includes scoring the card to provide a fold line for folding the card between the first portion and the second portion to create a “fold-over”.

FIG. 4 illustrates one method 400 for promoting a business, in accordance with one aspect of the invention. Method 400 begins at 410 by determining a selected day based on a business. The business can be for profit, not for profit, secular or nonsecular. For example, an insurance business card might show Monday as the beginning of the business week, while a church might show Sunday.

Based on the selected day, method 400 prints a card comprising contact information and a one day per week multi-year calendar defining a plurality of years at step 420. The printed card is then distributed to a plurality of customers at step 430. As used herein, the term “customer” means any potential or existing business partner or source of business. The card can be distributed in any number of methods, including personal contact, mail, or the like. Additionally, in one embodiment, the card is scored and folded along the score to create a folded card.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A business card comprising:
a front face and a back face, the front face including contact information and the back face including a one day per week multi-year calendar defining a plurality of years.

2. The card of claim 1 wherein the front face includes a contact information portion including the contact information and a day of interest portion including day of interest information and wherein the back face includes a calendar portion, and wherein the card includes a fold line separating the portions.

3. The card of claim 2 wherein the calendar information includes a day of interest information.

4. The card of claim 3 wherein the day of interest information includes an icon associated with at least one holiday.

5. The card of claim 1 wherein the one day per week is Monday.

6. The card of claim 1 wherein the one day per week is Saturday.

7. The card of claim 1 wherein the one day per week is Sunday.

8. The card of claim 1 wherein the calendar defines ten years.

9. The card of claim 1 wherein the calendar defines twelve years.

10. A method of printing a business card, the method including:
printing contact information on a front face of a card; and
printing a one day per week multi-year calendar defining a plurality of years on a back face of the card.

11. The method of claim 10 further comprising:
scoring the card to provide a fold line for folding the card between the first portion and second portion.

12. The method of claim 10 further comprising:
determining a selected day as the one day.

13. The method of claim 10 further comprising:
determining a day to print on the back face, and wherein printing a one day per week multi-year calendar comprises printing the selected day.

14. The method of claim 10 wherein printing the one day per week multi-year calendar comprises defining 10 years.

15. The method of claim 10 wherein printing the one day per week multi-year calendar comprises defining 12 years.

16. A method of promoting a business, the method comprising:
determining a selected day based on the business;
printing a card, the card comprising contact information and a one day per week multi-year calendar defining a plurality of years, the day based on the selected day; and
distributing the card to a plurality of customers.

17. The method of claim 16 further comprising:
scoring the card; and
folding the card along the score.

18. The method of claim 16 further comprising:
determining at least one day of interest associated with at least one of the business and customers; and
printing dates associated with determined day of interest for the plurality of years on the card.

19. The method of claim 16 wherein printing the one day per week multi-year calendar comprises defining 10 years.

20. The method of claim 16 wherein printing the one day per week multi-year calendar comprises defining 12 years.
